(19) United States
(12) Patent Application Publication
(10) Pub. No.: US 2012/0136510 A1
(43) Pub. Date: May 31, 2012

(54) APPARATUS AND METHOD FOR DETECTING VEHICLES USING LASER SCANNER SENSORS

(75) Inventors: Kyoung-Wook MIN, Daejeon (KR); Dong-Yong Kwak, Daejeon (KR); Dong-Sun Lim, Daejeon (KR)

(73) Assignee: Electronics and Telecommunications Research Institute, Daejeon (KR)

(21) Appl. No.: 13/305,980

(22) Filed: Nov. 29, 2011

(30) Foreign Application Priority Data
Nov. 30, 2010 (KR) 10-2010-0120732

(51) Int. Cl. G05D 1/00

(52) U.S. Cl. 701/2

(57) ABSTRACT

Disclosed herein is an apparatus for detecting vehicles using laser scanner sensors. The apparatus includes a vehicle location detection unit, a shadow area detection unit, an estimation unit, and a control unit. The vehicle location detection unit detects information about locations and headings of target vehicles located in a local detection area from sensors arranged on the road. The shadow area detection unit calculates shadow areas corresponding to the respective sensors based on the information about the locations of the target vehicles and information about types of the target vehicles. The estimation unit estimates the locations and shadow areas of the target vehicles which will be obtained after a predetermined time has elapsed. When a specific target vehicle tries to enter one of the estimated shadow areas, the control unit outputs a speed control command used to decrease the speed of the specific target vehicle.

### CROSS REFERENCE TO RELATED APPLICATION

This application claims the benefit of Korean Patent Application No. 10-2010-0120732, filed on Nov. 30, 2010, which is hereby incorporated by reference in its entirety into this application.

### BACKGROUND OF THE INVENTION

1. Technical Field

The present invention relates generally to an apparatus and method for detecting vehicles using laser scanner sensors, and, in particular, to an apparatus and method for detecting vehicles using laser scanner sensors, which prevents a case where a target vehicle enters a shadow area and the target vehicle cannot be accurately controlled when one or more unmanned autonomous vehicles are being controlled.

2. Description of the Related Art

According to existing unmanned autonomous vehicle technology, all the sensor devices, such as a laser scanner, a camera and radar, a computing device, and software used for vehicle control and autonomous traveling are provided in a vehicle, so that the vehicle moves autonomously according to a predetermined mission.

Sensors and computing devices provided in such an unmanned autonomous vehicle are very expensive, so that it is difficult to provide high accuracy sensors and high performance computing devices in a number of vehicles. Further, such an unmanned autonomous vehicle can only detect information about the vicinity thereof, so that the unmanned autonomous vehicle performs autonomous travel while the unmanned autonomous vehicle is unaware of events occurring in each area which deviates from a detection range.

Therefore, technologies for detecting vehicles and obstacles in such a way as to fix sensors on the road have been developed. In the case of a laser scanner sensor corresponding to one of the technologies, the laser scanner sensor detects an object using a reflection distance value obtained using laser. However, the laser scanner sensor fixed on the road cannot detect an object which is concealed by another object.

### SUMMARY OF THE INVENTION

Accordingly, the present invention has been made keeping in mind the above problems occurring in the prior art, and an object of the present invention is to provide an apparatus and method for detecting vehicles using laser scanner sensors, which adjusts the arrangement of laser scanner sensors, thereby minimizing shadow areas formed in a local detection area.

Further, another object of the present invention is to provide an apparatus and method for detecting vehicles using laser scanner sensors, which uses a shadow area avoidance model, thereby previously estimating the locations of target vehicles which are traveling in a local detection area and shadow areas formed by the respective target vehicles, and controlling the entrance of the target vehicles into the shadow areas.

Further, another object of the present invention is to provide an apparatus and method for detecting vehicles using laser scanner sensors, which uses a target vehicle left-side detection model in a shadow area, thereby, when a target vehicle is located in a shadow area, detecting another target vehicle which is located in the shadow area using the laser scanner sensor which is provided on one side of the corresponding target vehicle.

In order to accomplish the above objects, the present invention provides an apparatus for detecting vehicles using laser scanner sensors, the apparatus being included in a vehicle control server for controlling unmanned autonomous vehicles, the apparatus including: a vehicle location detection unit for detecting information about the locations and headings of target vehicles located in a local detection area, the information being received from sensors arranged on the road; a shadow area detection unit for calculating shadow areas corresponding to the respective sensors based on the information about the locations of the target vehicles and information about types of the target vehicles which is received from each of the target vehicles; an estimation unit for estimating the locations of the target vehicles and shadow areas, which will be obtained after a predetermined time has elapsed, on the estimated locations of the target vehicles; and a control unit for, when a specific target vehicle tries to enter one of the estimated shadow areas, outputting a speed control command used to decrease the speed of the specific target vehicle.

Here, the apparatus may use a shadow area avoidance model.

Meanwhile, the sensors may be laser scanner sensors and may be arranged on both sides of the road within the local detection area.

The shadow area detection unit may detect an area in which the shadow areas, corresponding to the respective sensors arranged on both sides of the road, overlap each other.

The shadow area estimation unit may estimate a location of the area, in which the shadow areas corresponding to the respective sensors overlap each other, which will be obtained after a predetermined time has elapsed.

The control unit may transmit locations of the target vehicle and the shadow area and a result of the estimation relative to the shadow area to the target vehicle when each of the target vehicles determines whether to enter the shadow area.

Meanwhile, in order to accomplish the above objects, the present invention provides an apparatus for detecting vehicles using laser scanner sensors, the apparatus being included in a vehicle control server for controlling unmanned autonomous vehicles, the apparatus including: a vehicle location detection unit for detecting information about the locations and headings of target vehicles located in a local detection area, the information being received from sensors arranged on the road; and a shadow area detection unit for calculating shadow areas corresponding to the respective sensors based on the information about the locations of the target vehicles and information about types of the target vehicles which is received from each of the target vehicles.

Here, the vehicle location detection unit, when a specific target vehicle is located in one of the shadow areas, may detect information about a location and heading of the specific target vehicle based on the information received from one of the target vehicles, which is located on one side of the corresponding shadow area.

Here, the apparatus uses a target vehicle left-side detection model in a shadow area.

Meanwhile, the sensors may be laser scanner sensors and may be arranged on both sides of the road within the local detection area.

The information received from the target vehicle may be detected by a sensor provided on one side of the target vehicle.

The apparatus may further include a control unit for transmitting information about locations of the specific target vehicle and the shadow area, and control information about the specific target vehicle to the specific target vehicle using one of the target vehicles.

In order to accomplish the above objects, the present invention provides a method for detecting vehicles using laser scanner sensors, the method being performed by a vehicle control server for controlling unmanned autonomous vehicles, the method including: detecting information about the locations and headings of target vehicles located in a local detection area, the information being received from sensors arranged on the road; calculating shadow areas corresponding to the respective sensors based on the information about the locations of the target vehicles and information about types of the target vehicles which is received from each of the target vehicles; estimating locations of the target vehicles and shadow areas, which will be obtained after a predetermined time has elapsed, based on the estimated locations of the target vehicles; and when a specific target vehicle tries to enter one of the estimated shadow areas, outputting a speed control command used to decrease the speed of the specific target vehicle.

Here, the method may use a shadow area avoidance model.

Meanwhile, the calculating the shadow areas may include detecting an area in which the shadow areas, corresponding to the respective sensors arranged on both sides of the road, overlap each other.

The estimating the shadow areas may include estimating a location of the area, in which the shadow areas corresponding to the respective sensors overlap each other, which will be obtained after a predetermined time has elapsed.

The method may further include, when each of the target vehicles determines whether to enter the shadow area, transmitting the locations of the target vehicle and the shadow area and a result of the estimation relative to the shadow area to the target vehicle.

Meanwhile, in order to accomplish the above objects, the present invention provides a method for detecting vehicles using laser scanner sensors, the method being performed by a vehicle control server for controlling unmanned autonomous vehicles, the method including: detecting information about the locations and headings of target vehicles located in a local detection area, the information being received from sensors arranged on the road; calculating shadow areas corresponding to the respective sensors based on the information about the locations of the target vehicles and information about types of the target vehicles which is received from each of the target vehicles; and when a specific target vehicle is located in one of the shadow areas, detecting information about a location and heading of the specific target vehicle based on the information received from one of the target vehicles, which is located on one side of the corresponding shadow area.

The method may use a target vehicle left-side detection model in shadow area.

The information received from the target vehicle may be detected by a sensor provided on one side of the target vehicle.

The method may further include transmitting information about locations of the specific target vehicle and the shadow area, and control information about the specific target vehicle to the specific target vehicle using one of the target vehicles.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating the operational principle of an apparatus for detecting vehicles using laser scanner sensors according to the present invention;

FIG. 2 is a view illustrating the configuration of a system to which the apparatus for detecting vehicles using laser scanner sensors according to the present invention is applied;

FIG. 3 is a block diagram illustrating the configuration of the apparatus for detecting vehicles using laser scanner sensors according to the present invention;

FIG. 4 is a block diagram illustrating the configuration of a target vehicle which is applied to the present invention;

FIGS. 5 to 7 are views illustrating the operation of the apparatus for detecting vehicles using laser scanner sensors according to the present invention; and

FIGS. 8 to 10 are flowcharts illustrating the operational flow of a method for detecting vehicles using laser scanner sensors according to the present invention.

### DESCRIPTION OF THE PREFERRED EMBODIMENTS

Embodiments of the present invention will be described with reference to accompanying drawings below.

Information about the current location and heading, that is, vehicle movement direction of the target vehicle is the most important information used to automatically lead a target vehicle using an unmanned autonomous vehicle system. Here, a vehicle control server controls a target vehicle along a predetermined path based on the information about the current location and heading corresponding to a target vehicle.

In order to detect the location and heading of a target vehicle, external road infra stationary sensors may be used instead of sensors provided in the target vehicle. Here, laser scanner sensors and image cameras may be used as external road infra stationary sensors.

It is assumed that laser scanner sensors are used in embodiments of the present invention. Such a laser scanner sensor (hereinafter referred to as a “sensor”) generally can sense an object which is separated from the sensor by a distance of 80 m in the range of 0° to 180° at intervals of 0.5° even though the distance, which can be detected, varies depending on the specifications of each sensor product.

As sensors are located away from target vehicles, fewer target vehicles can be detected by the sensors. Therefore, for the purpose of accurate detection, a local detection area is divided into a plurality of detection areas for each sensor. For example, a local detection area for a single sensor may be set to a section of 20 m. It is apparent that the local detection area may be set differently depending on the specifications of each sensor.

The apparatus for detecting vehicles using laser scanner sensors according to the present invention detects a target vehicle based on the two following models:

First model: shadow area avoidance model

Second model: target vehicle's left-side detection model in shadow area

Here, the first model uses a method of arranging sensors such that shadow areas are minimized and controlling the speed of target vehicles such that the target vehicles do not enter the shadow areas. Here, in order to minimize shadow areas, sensors may be arranged on both sides of the road included in a local detection area.

Meanwhile, the second model is a method of, when a target vehicle enters a shadow area in the state in which sensors are arranged such that shadow areas are minimized, detecting the target vehicle using a sensor of a vehicle provided on the right side of the target vehicle which entered the shadow area. That is, in the case of the second model, a sensor should be provided in the target vehicle.

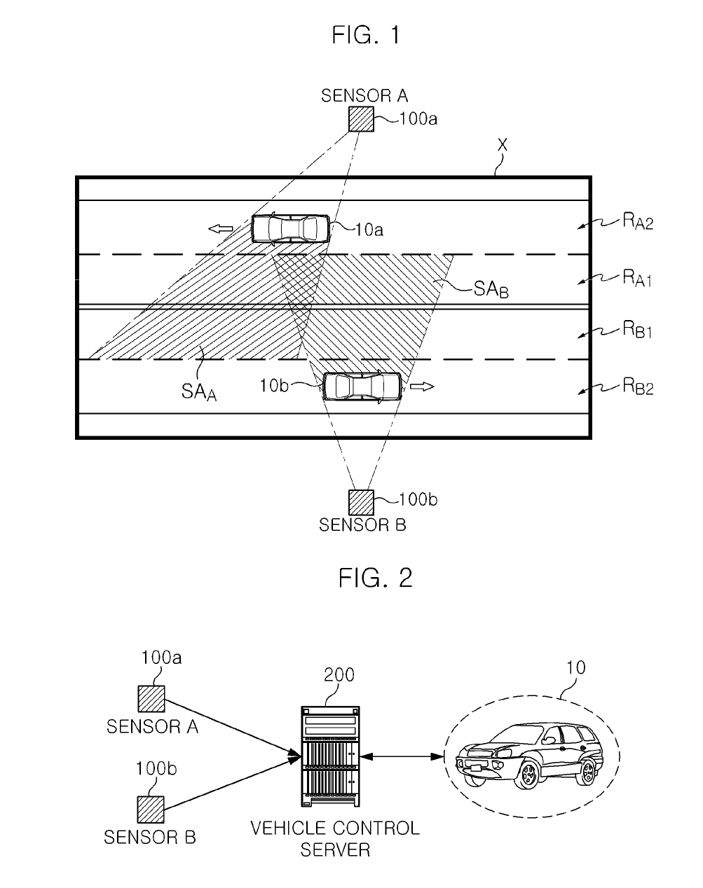

FIG. 1 is a view illustrating the general operational principle of an apparatus for detecting vehicles using laser scanner sensors according to the present invention. Although FIG. 1 illustrates an arrangement in which a sensor A 100a and a sensor B 100b are arranged at locations that are opposite to each other, the present invention is not limited thereto.

In FIG. 1, reference character X indicates a local detection area for the sensor A 100a and the sensor B 100b. Here, the sensor A 100a detects target vehicles located in the vehicle lanes R_{A1}, R_{A2}, and R_{B1} in the X area and the sensor B detects target vehicles located in the vehicle lanes R_{A1}, R_{B1}, and R_{B2} in the X area.

That is, the target vehicles 10a and 10b which exist in both outside lanes R_{A1} and R_{B2} are detected by the sensor A 100a and the sensor B 100b which are respectively near thereto, and target vehicles which exit in the both inside lanes R_{A1} and R_{B1} in both directions may be detected by both side sensors 100a and 100b.

Meanwhile, when the sensor A detects a target vehicle 10a in the R_{A2}, a shadow area corresponding to the sensor A 100a is formed by the target vehicle 10a. Further, when the sensor B 100b detects a target vehicle 10b in the R_{B2}, a shadow area corresponding to the sensor B 100b is formed by the target vehicle 10b.

Here, the shadow area refers to an area in which a signal from a sensor is blocked due to the target vehicle 10a or 10b, so that the sensor cannot perform detection in the local detection area X. FIG. 1 shows a shadow area SR_{A} corresponding to the sensor A 100a, which is formed by the target vehicle 10a in the R_{A2} and a shadow area SR_{B} corresponding to the sensor B 100b, which is formed by the target vehicle 10a in the R_{B2}.

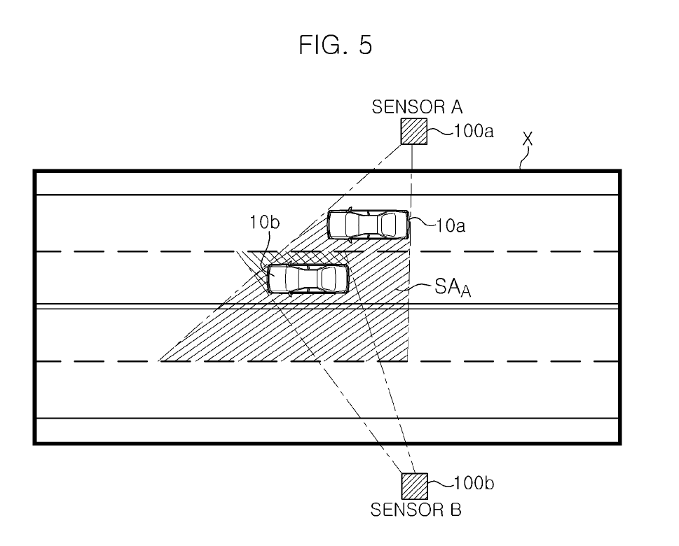

An operation of detecting target vehicles using sensors will be described in detail with reference to FIGS. 5 to 7.

FIG. 2 is a view illustrating the configuration of a system to which the apparatus for detecting vehicles using laser scanner sensors according to the present invention is applied.

As shown in FIG. 2, a vehicle control server 200 receives raw data from the sensor 100a or 100b and controls a target vehicle 10 based on the raw data. It is apparent that the vehicle control server 200 may receive general information about the target vehicle 10 from each target vehicle 10.

The vehicle control server 200 detects the received information about the type, location and heading, that is, vehicle movement direction of the target vehicle 10, and then calculates a shadow area formed by the corresponding target vehicle 10. Further, the vehicle control server 200 may estimate the location and shadow area of the target vehicle 10, which will be obtained after a predetermined time t has elapsed.

Here, a single vehicle control server 200 may exist for each local detection area or a single vehicle control server 200 may exist for the entire server area.

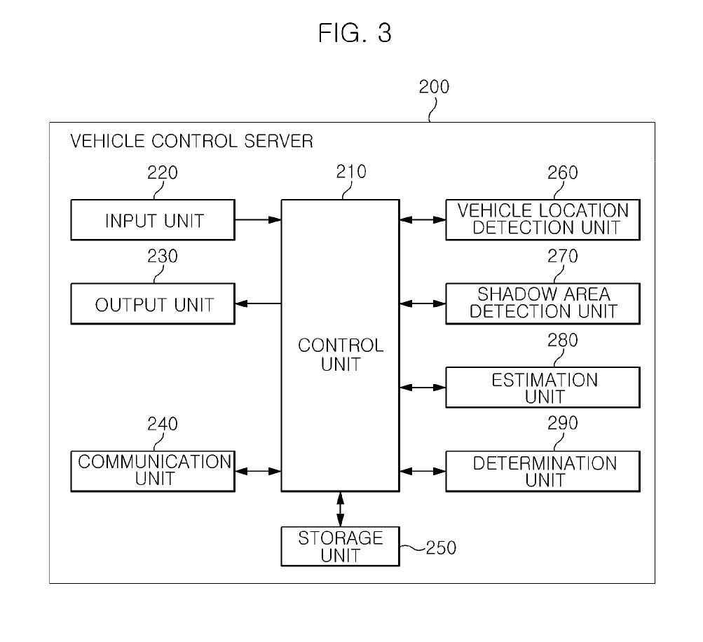

The vehicle control server 200 will be described in detail with reference to an embodiment of FIG. 3.

FIG. 3 is a block diagram illustrating the configuration of the apparatus for detecting vehicles using laser scanner sensors according to the present invention, that is, the configuration of the vehicle control server 200.

As shown in FIG. 3, the vehicle control server 200 according to the present invention includes a control unit 210, an input unit 220, an output unit 230, a communication unit 240, a storage unit 250, a vehicle location detection unit 260, a shadow area detection unit 270, an estimation unit 280, and a determination unit 290. Here, the control unit 210 controls the operations of the respective units of the vehicle control server 200.

The configuration of each unit will is described below. If there is not a specific description, the configuration will be described for the case where the vehicle control server 200 operates based on the first model and the case where the vehicle control server 200 is commonly applied to the first and second models. The configuration for the case where the vehicle control server 200 operates based on the second model will be described separately.

The input unit 220 is means for receiving a control command from a manager. The output unit 230 is means for outputting detected, calculated or estimated information about the target vehicle.

The communication unit 240 is connected to the sensors, and is configured to receive raw data about the target vehicle from the sensors. Further, a communication unit 240 is connected to the target vehicle to provide communication, and is configured to receive information about the target vehicle or transmit information about control of the target vehicle and information about estimation of shadow area. Here, although the communication unit 240 generally communicates with the sensors and target vehicles in a wireless manner, the communication unit 240 may communicate with the sensors in a wired manner if necessary.

The storage unit 250 stores general information about a target vehicle, which was registered in a wireless autonomous vehicle system, and stores information about lanes in a local detection area, and information about a corresponding region.

When raw data is received from the sensor via the communication unit 240, the vehicle location detection unit 260 detects information about the location and heading of the target vehicle in the local detection area based on the raw data. When there are a plurality of target vehicles in the local detection area, raw data can be received from each target vehicle and single raw data may include information about each target vehicle. Therefore, the vehicle location detection unit 260 recognizes the information about the location and heading of each target vehicle located in the local detection area based on the received raw data.

Meanwhile, when the vehicle control server 200 operates based on the second model, the vehicle location detection unit 260 receives raw data from a specific target vehicle (hereinafter referred to as “first target vehicle”), the raw data being about another target vehicle (hereinafter referred to as “second target vehicle”) which is located in a shadow area formed by the specific target vehicle. Here, the vehicle location detection unit 260 recognizes information about the location and heading of the second target vehicle which is located in the corresponding shadow area based on the raw data about the second target vehicle.

The shadow area detection unit 270 calculates a shadow area based on the location of the first target vehicle detected by the vehicle location detection unit 260 and information about the shape, such as the size, of the first target vehicle, which is received from the first target vehicle. That is, the shadow area detection unit 270 calculates the shadow area formed by the first target vehicle based on the location of the sensor which transmitted the raw data and based on the location and size (width) of the first target vehicle.

Meanwhile, when the vehicle control server 200 operates based on the second model, the shadow area detection unit 270 calculates a shadow area formed by the second target vehicle based on the location of the second target vehicle, which was detected by the vehicle location detection unit 260, and based on information about the shape of the second target vehicle.

The estimation unit 280 estimates the location of the target vehicle which will be obtained after a predetermined time t has elapsed, information about heading of the target vehicle, and a shadow area based on the target vehicle. For example, the estimation unit 280 may estimate the location of the target vehicle which will be obtained after a predetermined time has elapsed based on variation in the location of the target vehicle and information about the heading of the target vehicle which are detected by the vehicle location detection unit 260 in real time. Here, the estimation unit 280 may also estimate a shadow area with respect to the estimated location of the target vehicle.

The determination unit 290 determines whether the second target vehicle enters the shadow area of the first target vehicle based on the location of the first target vehicle, information about the heading of the target vehicle, and the results of the shadow area estimation which were obtained by the estimation unit 280. Here, the determination unit 290 compares the location and the shadow area of the first target vehicle estimated by the estimation unit 280 with the location of the second target vehicle, and compares information about the heading of the first target vehicle with information about the heading of the second target vehicle, thereby determining whether the second target vehicle will enter the corresponding shadow area.

The determination unit 290 outputs the result of the determination to the control unit 210. Therefore, if, as the result of the determination performed by the determination unit 290, it is determined that the second target vehicle will enter the shadow area of the first target vehicle, the control unit 210 generates a speed control command for the second target vehicle, and then transmits the speed control command to the second target vehicle using the communication unit 240. Here, the control unit 210 transmits the speed control command used to reduce the speed of the second target vehicle, thereby preventing the second target vehicle from entering the shadow area.

Meanwhile, if, as the result of the determination performed by the determination unit 290, it is determined that the second target vehicle will not enter the shadow area of the first target vehicle, the control unit 210 does not generate a separate control command.

However, when the vehicle control server 200 operates based on a vehicle active method, each target vehicle determines whether to enter a shadow area or not, so that the determination unit 290 does not determine whether the target vehicle will enter a shadow area. In this case, the control unit 210 transmits information about the detection of a target vehicle, information about detection of a shadow area, and information about estimation of a shadow area to the target vehicle.

Here, the vehicle active method corresponds to a method of enabling a target vehicle to perform an operation of determining whether to enter a shadow area in order to prevent the target vehicle from entering the shadow area. An embodiment of the present invention will be described with reference to the case where the vehicle control server 200 operates based on a server active method of enabling a server to perform an operation of determining whether a target vehicle will enter a shadow area.

Meanwhile, when the vehicle control server 200 operates based on the second model, the vehicle control server 200 may detect a second target vehicle which is located in a shadow area using a sensor 100c provided in a first target vehicle, so that the estimation unit 280 and the determination unit 290 do not estimate the location and shadow area of the first target vehicle nor determine whether the second target vehicle will enter the shadow area. In this case, the control unit 210 transmits information about the detection of the second target vehicle and information about the detection of the shadow area to the first target vehicle.

Here, the first target vehicle, which received the information about the detection of the second target vehicle and the information about the detection of the shadow area from the vehicle control server 200, transmits the received information to the second target vehicle which is located in the shadow area of the first target vehicle. Here, the first target vehicle may transmit and receive information to and from second target vehicle via vehicle-to-vehicle communication.

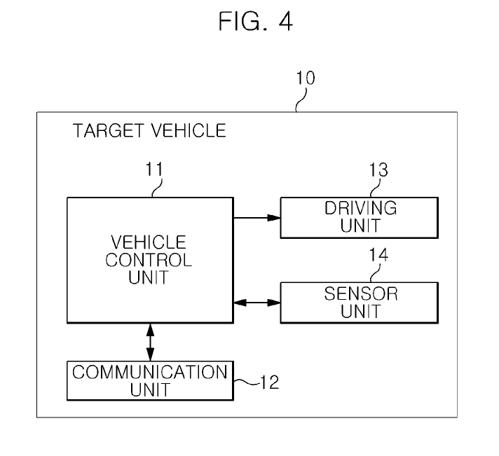

FIG. 4 is a block diagram illustrating the configuration of the target vehicle which is applied to the present invention.

As shown in FIG. 4, the target vehicle 10 according to the present invention includes a vehicle control unit 11, a communication unit 12, a driving unit 13, and a sensor unit 14. Here, the vehicle control unit 11 controls the operations of the respective units of the target vehicle 10.

First, the communication unit 12 is connected to the vehicle control server for communication, and is configured to transmit information about the target vehicle 10, information about the control of the target vehicle 10, and information about the estimation of a shadow area to the vehicle control server. Further, the communication unit 12 communicates with the second target vehicle 10 located in a shadow area which was formed by the first target vehicle 10. Here, the communication unit 12 communicates with the vehicle control server and the second target vehicle 10 in a wireless manner.

Generally, since the target vehicle 10 is an unmanned autonomous vehicle, the target vehicle 10 receives a driving command from the vehicle control server, and the driving unit 13 controls the operations, such as braking, accelerating, and steering, of the target vehicle 10 based on the received driving command.

Here, the control unit transmits general information about the target vehicle 10, such as the size and shape of the target vehicle 10, to the vehicle control server using the communication unit 12 while the target vehicle 10 is traveling or before the target vehicle 10 travels.

Meanwhile, when the vehicle control server operates based on the server active method, the control unit receives information about the location of the target vehicle, information about the heading of the target vehicle, information about the detection of a shadow area, and a control command based on the results of the estimation of the shadow area from the vehicle control server. Here, the control command is received when it is determined that the corresponding target vehicle 10 will enter a shadow area after a predetermined time has elapsed. Therefore, the control unit transmits the control command to the driving unit 13, thereby preventing the corresponding target vehicle 10 from entering the shadow area.

Meanwhile, when the target vehicle 10 operates based on the vehicle active method, the control unit receives information about the location of the target vehicle, information about the heading of the target vehicle, information about the detection of a shadow area, and information about the estimation of a shadow area from the vehicle control server. Therefore, the control unit determines whether the corresponding target vehicle 10 will enter the shadow area after a predetermined time has elapsed based on the information about the estimation of a shadow area.

If it is determined that the corresponding target vehicle 10 will enter the shadow area after a predetermined time has elapsed, the control unit outputs a control signal to the driving unit 13, thereby controlling the speed of the target vehicle 10.

The sensor unit 14 is used when the vehicle control server and a first target vehicle 10 operate based on the second model. Here, the sensor unit 14 includes a laser scanner sensor, and is provided on the left-side surface of the first target vehicle 10 (however, the sensor unit 14 is provided on the right-side surface when traffic must keep to the left, unlike Korea). Here, the sensor unit 14 detects a second target vehicle 10 in a shadow area formed by the first target vehicle 10 while the sensor performs a detection operation within the local detection area.

When sensor unit 14 detects the second target vehicle 10 in the shadow area, the control unit generates raw data for the second target vehicle 10 and transmits the raw data to the vehicle control server. Further, when the information about the detection of the second target vehicle 10 and the information about the estimation of the shadow area which correspond to the raw data, transmitted to the vehicle control server, are received from the vehicle control server, the control unit transmits the received information to the second target vehicle 10 located in the shadow area using the communication unit 12.

FIGS. 5 to 7 are exemplary views illustrating the operation of the apparatus for detecting vehicles using laser scanner sensors according to the present invention.

First, FIG. 5 is a view illustrating the general sensor operation applied to the present invention.

As shown in FIG. 5, the sensor A 100a and the sensor B 100b are arranged at locations, which are opposite to each other, on both sides of a road, and are configured to detect target vehicles 10a and 10b which are traveling the local detection area X.

First, the sensor A 100a detects the target vehicle A 10a. Here, a shadow area SR_{A} is formed by the target vehicle A 10a in the detection area of the sensor A 100a. Therefore, although a road on which the target vehicle B 10b is traveling corresponds to the detection area of the sensor A 100a, it corresponds to the shadow area of the target vehicle A 10a, so that the sensor A 100a cannot detect the target vehicle B 10b. In this case, a road on which the target vehicle B 10b is traveling also corresponds to the detection area of the sensor B 100b, and the sensor B 100b detects the target vehicle B 10b.

Therefore, when the sensor A 100a and the sensor B 100b are arranged on both sides of the road, the target vehicle located in the shadow area can be detected.

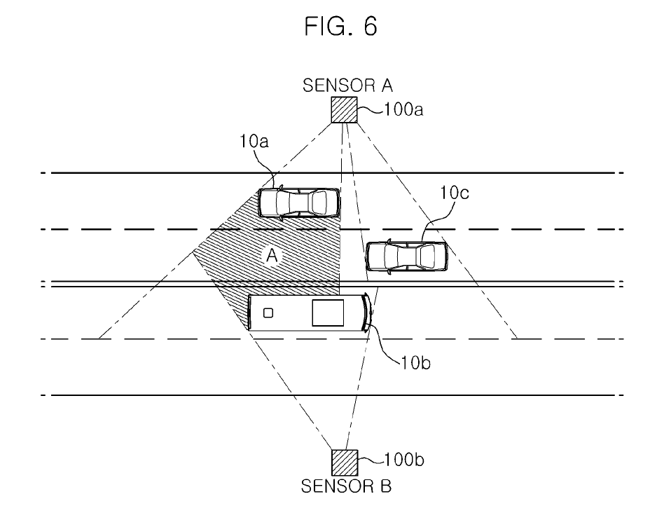

FIG. 6 illustrates sensor operation when the vehicle control server according to the present invention operates based on the first model.

As shown in FIG. 6, the sensor A 100a detects the target vehicle A 10a and the target vehicle C 10c. Further, the sensor B 100b detects the target vehicle B 10b.

Here, shadow areas are formed by the target vehicle A 10a and the target vehicle C 10c in the detection area of the sensor A 100a, and a shadow area is formed by the target vehicle B 10b in the detection area of the sensor B 100b.

In FIG. 6, a region A indicates a region in which the shadow area of the target vehicle A 10a overlaps the shadow area of the target vehicle B 10b. Therefore, the target vehicle located in the region A cannot be detected by the sensor A 100a or the sensor B 100b.

In this case, the vehicle control server (which operates based on the server active method) or the target vehicle C 10c (which operates based on the vehicle active method) determines whether the target vehicle C 10c will enter the region A after a predetermined time t has elapsed. Here, if it is determined that the target vehicle C 10c will enter the region A after the predetermined time t has elapsed, the vehicle control server or the target vehicle C 10c controls the speed of the target vehicle C 10c, thereby preventing the target vehicle C 10c from entering the region A. Therefore, a target vehicle which is located in the local detection area is prevented from not being detected by the sensor A 100a and the sensor B 100b.

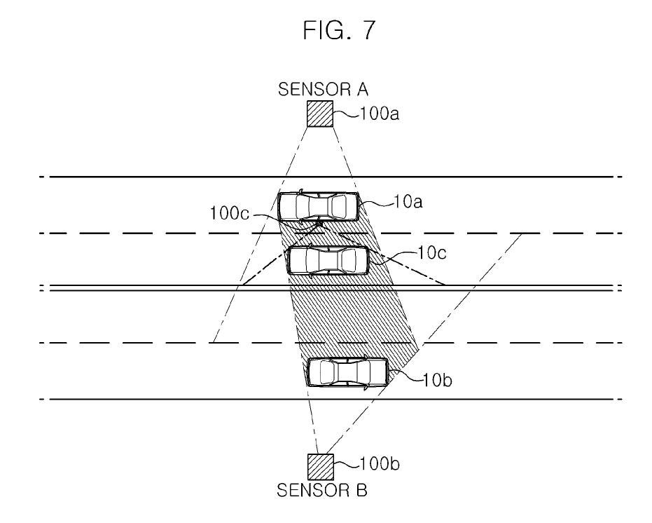

Meanwhile, FIG. 7 is a view illustrating the operation of sensors in the case where the vehicle control server according to the present invention operates based on the second model.

As shown in FIG. 7, the sensor A 100a detects the target vehicle A 10a and the sensor B 100b detects the target vehicle B 10b. Here, a shadow area is formed by the target vehicle A 10a in the detection area of the sensor A 100a and a shadow area is formed by the target vehicle B 10b in the detection area of the sensor B 100b.

In FIG. 7, a region in which the shadow area of the target vehicle A 10a overlaps the shadow area of the target vehicle B 10b is formed as in the region A of FIG. 6. FIG. 7 illustrates a case where the target vehicle C 10c is located in the shadow area formed by the target vehicle A 10a and the target vehicle B 10b, unlike the embodiment of FIG. 6.

In this case, the sensor A 100a and the sensor B 100b cannot detect the target vehicle C 10c. Therefore, the target vehicle A 10a uses the sensor C 100c of the sensor unit 14 to detect the target vehicle C 10c located in the shadow area of the target vehicle A 10a.

That is, in the embodiment of FIG. 6, it is difficult to detect all the target vehicles as the number of lanes increases and the number of target vehicles on the road increases. Therefore, in this case, all the target vehicles can be detected based on the second model as in FIG. 7.

The operational flow of the present invention having the above-described configuration will be described in further detail.

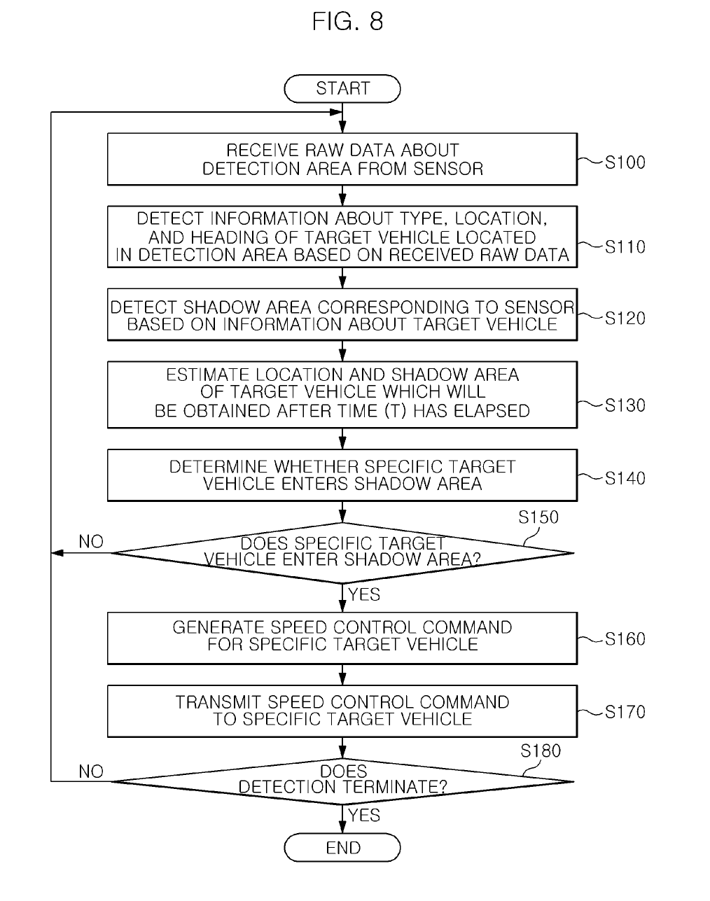

FIGS. 8 to 10 are flowcharts illustrating the operational flow of a method for detecting vehicles using laser scanner sensors according to the present invention.

First, FIG. 8 illustrates an operational flow when the vehicle control server operates based on the first model and the server active method.

When the target vehicle enters a local detection area, the target vehicle transmits information about the vehicle, for example, information about the size of the vehicle to the vehicle control server. It is apparent that the vehicle control server stores the information about the vehicle from the target vehicle. Here, the information about the size of the vehicle is used to detect the location, heading direction and shadow area of the vehicle. The information about the target vehicle may be previously registered in the vehicle control server.

Meanwhile, as shown in FIG. 8, the vehicle control server receives the raw data of target vehicles which entered the local detection area from the sensor at step S100. Here, the vehicle control server detects information about the locations and heading of the target vehicles which are located in the local detection area based on the raw data, received at step S100, at step S110.

Further, the vehicle control server detects a shadow area corresponding to the sensor for detecting the local detection area based on the information about the target vehicles, detected at step S110, at step S120.

When the information about the location, heading, and shadow area of a first target vehicle is detected, the vehicle control server estimates the location and shadow area of the first target vehicle, which will be obtained after a predetermined time t has elapsed at step S130, and then determines whether a second target vehicle will enter the estimated shadow area at step S140.

If, as the result of the determination at step S140, it is determined that the second target vehicle will not enter the shadow area at step S150, the vehicle control server returns to step S100 and then performs the process again.

Meanwhile, if, as the result of the determination at step S140, it is determined that the second target vehicle will enter the shadow area at step S150, the vehicle control server generates a speed control command for the second target vehicle which will enter the shadow area at step S160, and then transmits the speed control command to the second target vehicle at step S170. Here, the vehicle control server transmits the speed control command together with the information about the location and heading of the second target vehicle and information about the estimation of the shadow area thereof in the local detection area.

Thereafter, the vehicle control server repeatedly performs the process from step S100 to S170 until the detection operation ends, thereby controlling the second target vehicle which will enter the shadow area of the local detection area.

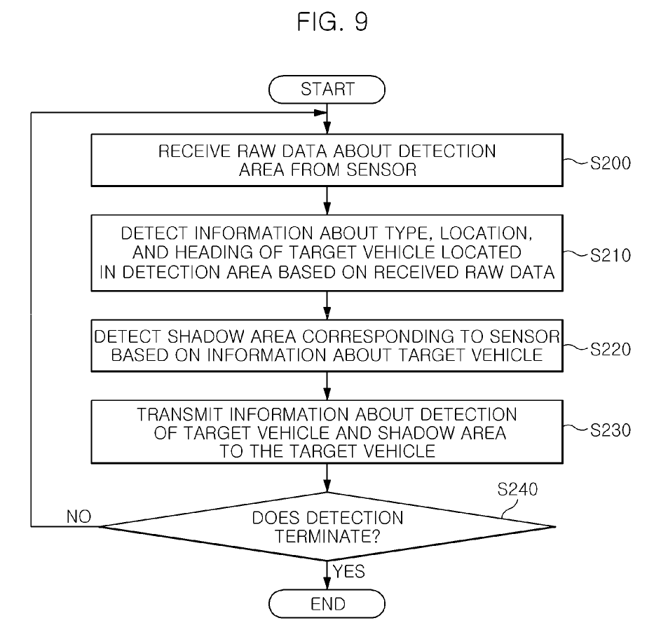

FIG. 9 is a flowchart illustrating operational flow when the vehicle control server operates based on the vehicle active method.

With regard to the vehicle active method shown in FIG. 9, each target vehicle determines whether to enter a shadow area, so that the vehicle control server does not determine whether a second target vehicle will enter the shadow area unlike FIG. 8.

Therefore, as shown in FIG. 9, the vehicle control server which operates based on the vehicle active method receives raw data about target vehicles which entered a local detection area from the sensors at step S200. Here, the vehicle control server detects information about the location and heading of each target vehicle located in the local detection area based on the raw data, received at step S200, at step S210.

Further, the vehicle control server detects each shadow area corresponding to the sensor for detecting the local detection area based on the information about the target vehicle, detected at step S210, at step S220.

When the information about the location and heading of the target vehicle and the shadow area thereof are detected, the vehicle control server estimates the location and shadow area of the target vehicle which will be obtained after a predetermined time t has elapsed. Thereafter, the vehicle control server transmits information about the detection of the target vehicle and the shadow area and information about the estimation of the shadow area to the target vehicle at step S230.

Therefore, the target vehicle determines whether the corresponding target vehicle will enter the shadow area based on the information about the detection of the target vehicle and the shadow area thereof and information about the estimation of the shadow area from the vehicle control server, and then controls the speed of the corresponding target vehicle based thereon.

The vehicle control server performs the process from step S200 to S240 until the detection operation ends.

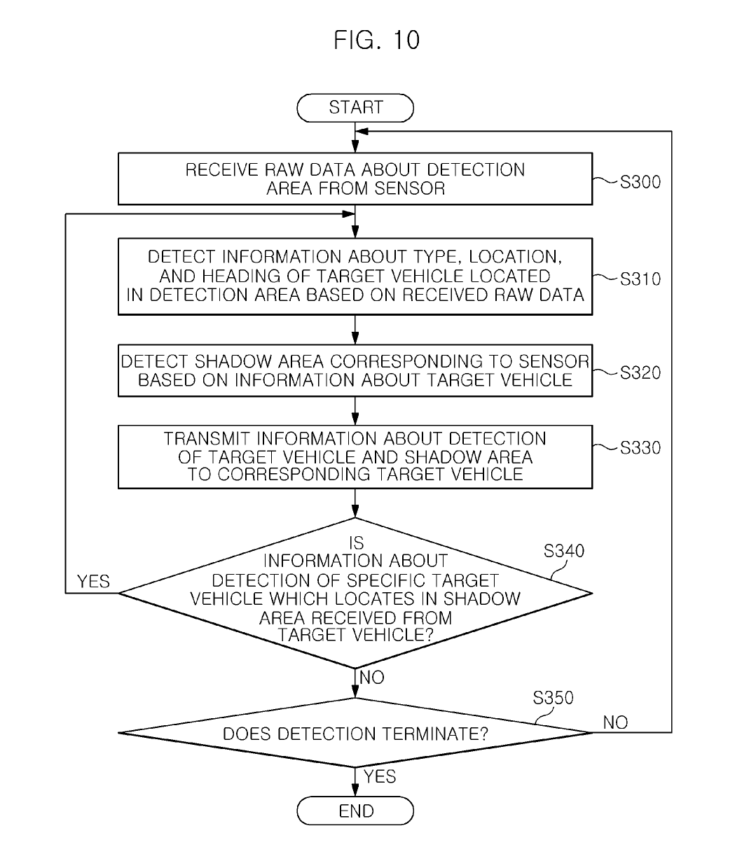

FIG. 10 is a flowchart illustrating operational flow when the vehicle control server operates based on the second model.

The method of the second model shown in FIG. 10 enables the first target vehicle to detect the second target vehicle located in the shadow area of the corresponding target vehicle using the sensor 100c, the vehicle control server does not estimates a shadow area nor determine whether the second target vehicle will enter the estimated shadow area, unlike FIG. 8.

Therefore, as shown in FIG. 10, the vehicle control server, which operates based on the second method, receives raw data about target vehicles which entered a local detection area from the sensors at step S300. Here, the vehicle control server detects information about the locations and headings of the target vehicles located within the local detection area based on the raw data, received at step S300, at step S310.

Further, the vehicle control server detects the shadow areas corresponding to the sensors for detecting the local detection area based on the information about the target vehicles, detected at step S310, at step S320.

Thereafter, the vehicle control server transmits information about the detection of the target vehicle and the shadow area, obtained at steps S310 and S320, to each target vehicle at step S330.

Thereafter, when the vehicle control server receives the raw data about another target vehicle (second target vehicle) located in the shadow area from the target vehicle (first target vehicle) at step S340, the vehicle control server detects information about the location and heading of the second target vehicle based on the raw data about the second target vehicle, received at step S340, at step S310.

Further, the vehicle control server detects a shadow area corresponding to the sensor provided in the first target vehicle based on the information about the second target vehicle, detected at step S310, at step S320. The vehicle control server transmits the information about the detection of the second target vehicle and the corresponding shadow area, which was obtained at steps S310 and S320, to the first target vehicle which transmitted the raw data of the second target vehicle at step S340.

Therefore, the first target vehicle transmits the information received from the vehicle control server to the second target vehicle.

Meanwhile, if the raw data about the second target vehicle is not received from the first target vehicle after step S330 was performed, the vehicle control server repeatedly performs the processes from step S300 to S440 until the detection operation ends.

According to the present invention, the arrangement of laser scanner sensors is adjusted, so that there is an advantage of minimizing a shadow area formed in a local detection area.

Further, the present invention uses the shadow area avoidance model, so that there are advantages of previously estimating the locations of target vehicles which are traveling within a local detection area and shadow areas formed by the target vehicles, and preventing the target vehicles from entering the shadow areas.

Further, the present invention uses the target vehicle left-side detection model in a shadow area, a second target vehicle which is located in the shadow area of a first target vehicle can be detected using a laser scanner sensor provided on the side of the first target vehicle when the second target vehicle is located in the shadow area of the first target vehicle, so that there is an advantage of removing one or more elements which interrupt the control of an unmanned autonomous vehicle.

Although the preferred embodiments of the apparatus and method for detecting vehicles using laser scanner sensors according to the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for detecting vehicles using laser scanner sensors, the apparatus being included in a vehicle control server for controlling unmanned autonomous vehicles, the apparatus comprising:
a vehicle location detection unit for detecting information about locations and headings of target vehicles located in a local detection area, the information being received from sensors arranged on a road, the target vehicles are controlled by the vehicle control server;
a shadow area detection unit for calculating shadow areas corresponding to the respective sensors based on the information about the locations of the target vehicles and information about types of the target vehicles which is received from each of the target vehicles;
an estimation unit for estimating locations of the target vehicles and shadow areas, which will be obtained after a predetermined time has elapsed, based on the estimated locations of the target vehicles; and
a control unit for, when a specific target vehicle tries to enter one of the estimated shadow areas, outputting a speed control command used to decrease a speed of the specific target vehicle.

2. The apparatus as set forth in claim 1, wherein the apparatus uses a shadow area avoidance model.

3. The apparatus as set forth in claim 1, wherein the sensors are laser scanner sensors and are arranged on both sides of the road within the local detection area.

4. The apparatus as set forth in claim 3, wherein the shadow area detection unit detects an area in which the shadow areas, corresponding to the respective sensors arranged on both sides of the road, overlap each other.

5. The apparatus as set forth in claim 4, wherein the shadow area estimation unit estimates a location of the area, in which the shadow areas corresponding to the respective sensors overlap each other, which will be obtained after a predetermined time has elapsed.

6. The apparatus as set forth in claim 1, wherein the control unit, when each of the target vehicles determines whether to enter the shadow area, transmits locations of the target vehicle and the shadow area and a result of the estimation relative to the shadow area to the target vehicle.

7. An apparatus for detecting vehicles using laser scanner sensors, the apparatus being included in a vehicle control server for controlling unmanned autonomous vehicles, the apparatus comprising:
a vehicle location detection unit for detecting information about locations and headings of target vehicles located in a local detection area, the information being received from sensors arranged on a road; and
a shadow area detection unit for calculating shadow areas corresponding to the respective sensors based on the information about the locations of the target vehicles and information about types of the target vehicles which is received from each of the target vehicles;
wherein the vehicle location detection unit, when a specific target vehicle is located in one of the shadow areas, detects information about a location and heading of the specific target vehicle based on the information received from one of the target vehicles, which is located on one side of the corresponding shadow area.

8. The apparatus as set forth in claim 7, wherein the apparatus uses a target vehicle left-side detection model in a shadow area.

9. The apparatus as set forth in claim 7, wherein the sensors are laser scanner sensors and are arranged on both sides of the road within the local detection area.

10. The apparatus as set forth in claim 7, wherein the information received from the target vehicle is detected by a sensor provided on one side of the target vehicle.

11. The apparatus as set forth in claim 7, further comprising a control unit for transmitting information about locations of the specific target vehicle and the shadow area, and control information about the specific target vehicle to the specific target vehicle using one of the target vehicles.

12. A method for detecting vehicles using laser scanner sensors, the method being performed by a vehicle control server for controlling unmanned autonomous vehicles, the method comprising:
detecting information about locations and headings of target vehicles located in a local detection area, the information being received from sensors arranged on a road;
calculating shadow areas corresponding to the respective sensors based on the information about the locations of the target vehicles and information about types of the target vehicles which is received from each of the target vehicles;
estimating locations of the target vehicles and shadow areas, which will be obtained after a predetermined time has elapsed, based on the estimated locations of the target vehicles; and
when a specific target vehicle tries to enter one of the estimated shadow areas, outputting a speed control command used to decrease a speed of the specific target vehicle.

13. The method as set forth in claim 12, wherein the method uses a shadow area avoidance model.

14. The method as set forth in claim 12, wherein the calculating the shadow areas comprises detecting an area in which the shadow areas, corresponding to the respective sensors arranged on both sides of the road, overlap each other.

15. The method as set forth in claim 14, wherein the estimating the shadow areas comprises estimating a location of the area, in which the shadow areas corresponding to the respective sensors overlap each other, which will be obtained after a predetermined time has elapsed.

16. The method as set forth in claim 12, further comprising, when each of the target vehicles determines whether to enter the shadow area, transmitting the locations of the target vehicle and the shadow area and a result of the estimation relative to the shadow area to the target vehicle.

17. A method for detecting vehicles using laser scanner sensors, the method being performed by a vehicle control server for controlling unmanned autonomous vehicles, the method comprising:
detecting information about locations and headings of target vehicles located in a local detection area, the information being received from sensors arranged on a road;
calculating shadow areas corresponding to the respective sensors based on the information about the locations of the target vehicles and information about types of the target vehicles which is received from each of the target vehicles; and
when a specific target vehicle is located in one of the shadow areas, detecting information about a location and heading of the specific target vehicle based on the information received from one of the target vehicles, which is located on one side of the corresponding shadow area.

18. The method as set forth in claim 17, wherein the method uses a target vehicle left-side detection model in shadow area.

19. The method as set forth in claim 17, wherein the information received from the target vehicle is detected by a sensor provided on one side of the target vehicle.

20. The method as set forth in claim 17, further comprising transmitting information about locations of the specific target vehicle and the shadow area, and control information about the specific target vehicle to the specific target vehicle using one of the target vehicles.
